(19) United States
(12) Patent Application Publication
(10) Pub. No.: US 2018/0167752 A1
(43) Pub. Date: Jun. 14, 2018

(54) HEARING AID WITH AN EXTENDED DOME

(71) Applicant: Oticon A/S, Smørum (DK)

(72) Inventors: Thor Højlund OLSEN, Smørum (DK); Troels Holm PEDERSEN, Smørum (DK); Claus NIELSEN, Smørum (DK); Svend Oscar PETERSEN, Smørum (DK); Kenneth Rueskov MØLLER, Smørum (DK); Lars Steen CHRISTENSEN, Smørum (DK); Thomas LUNNER, Smørum (DK)

(73) Assignee: Oticon A/S, Smørum (DK)

(21) Appl. No.: 15/837,360

(22) Filed: Dec. 11, 2017

(30) Foreign Application Priority Data
Dec. 12, 2016 (EP) 16203465.6

(51) Int. Cl. H04R 25/00

(52) U.S. Cl. CPC H04R 25/652; H04R 2225/025; H04R 2225/021; H04R 25/658

(57) ABSTRACT

A dome for attachment to an in the ear canal element is disclosed. The dome is configured to be inserted into an ear canal of a user and comprises a front portion adapted to be brought into contact with an ear canal of the user, wherein the dome comprises a through-going sound canal and an elongated intermediate portion configured to extend front portion.

### FIELD

The present disclosure relates to a dome for attachment to an in the ear canal element.

### BACKGROUND

Domes used on Receiver In The Ear, RITE hearing instruments are typically placed in the first third of the ear canal beyond the first bend of the ear canal. A deeply seated dome at or beyond the second bend of the ear canal have, however, several advantages.

By applying a deeply seated dome it is possible to achieve a high sound pressure in the ear canal due to the reduced residual cavity thus enabling a larger hearing loss fitting range. Little or no occlusion effect is associated with deeply seated domes, since the domes are placed in the bony hard part of the ear canal, in which no vibration of the canal walls takes place whilst talking, chewing or performing other facial movements.

Thus, it would be desirable to provide a dome, which can be extended deep into the ear. The present disclosure provides at least an alternative to the prior art.

### SUMMARY

According to an aspect of the disclosure the dome is a dome for attachment to an in the ear canal element, the dome being configured to be inserted into an ear canal of a user and comprising a front portion adapted to be brought into contact with an ear canal of the user, wherein the dome comprises a through-going sound canal and an elongated intermediate portion extending between a front surface of the front portion facing a tympanic membrane when inserted into the ear canal and an attachment area of said dome, the attachment area being configured to receive at least a portion of the in the ear canal element, wherein at least the front portion is adapted to substantially reach into a bony region of the ear canal of the user.

In other words the dome is configured to be attached to especially an in the ear canal element, which is configured as a receiver. Accordingly, the disclosure is especially focusing on a solution which covers a receiver-in-the-ear type hearing aid. That is the in the ear canal element, should preferably be construed as a receiver, which are configured to be connected to said dome, wherein the dome comprises two portion, i.e. the front portion and an additional rear portion, wherein the rear portion at least accommodates the receiver, when the receiver and the dome are connected to each other. In more detail, the front and rear portion may be connected through an intermediate portion, which intermediate portion is substantially accommodated in said front portion of the dome.

Hereby, it is possible to provide a dome, which can be extended deep into the ear. Especially the construction of the dome with a front portion and a rear portion, which are connected with an elongated intermediate portion, allows the dome to be extended further into the ear canal when inserted therein, achieving a substantially better sound quality due to an improved seal of the bony region of the ear canal.

It should be noted that without the elongated intermediate portion, the dome could not be extended as deep into the bony region of the ear canal as desired.

The ear canal of humans are narrowing the father one reaches the inner parts of the ear canal, and therefore the front portion may be configured with a smaller sized dome than the rear portion. This allows a deep insertion into the bony region, while sealing efficiently. Accordingly, the dome of the front portion, may be configured with a substantially smaller diameter than the rear portion, as will become apparent throughout the description of the figures, merely disclosing examples according to the disclosure.

As will become apparent throughout the description, the elongated intermediate portion, may be configured with attachment structures, which are configured in an attachment area.

Furthermore, it should be noted that a hearing aid comprising the above mentioned dome is also disclosed herein. That is, the hearing aid may comprise a behind the ear unit, which are connected to a tube, preferably configured with one or more connections, which in an end of the tube is connected to a receiver. As previously described, the receiver (also denoted the in the ear element) is configured to be attached to the dome according to disclosure. Accordingly, the receiver is configured to be connected to at least the rear portion of the dome, and configured to substantially transmit sound from a sound outlet, arranged in a transition area between the rear and the front portion, through the intermediate portion and an opening in the front dome, to the ear of a user.

Accordingly, it is possible to achieve a high sound pressure in the ear canal because of the reduced residual cavity thus enabling a larger hearing loss fitting range. Furthermore, the occlusion effect can be decreased or even eliminated because the dome is placed in the bony hard part (i.e. the bony region) of the ear canal, in which no vibration of the canal walls takes place whilst e.g. talking or performing other facial movements.

The dome according to the disclosure makes it possible to make a better reproduction of low frequencies due to the efficient acoustic sealing of the dome towards the ear canal.

It should be noted that the rear portion primarily allows to keep the front portion in place e.g. prevent tilting of the dome of the front portion and thereby prevent a possible unwanted leak.

Furthermore, it should be noted that the extension of the dome (elongated intermediate tube, also defined as the tube from the opening of the speaker to the sound outlet of the dome) support a more shallow placement of the receiver in the ear canal, which is an advantage because there is more space here. This means that the solution according to the disclosure can provide a bony sealed fit also in ears with smaller ear canals.

Hearing aid users usually have to choose between sound quality and high fitting range (closed domes) on one hand and no occlusion (open domes) on the other hand. By extending the dome into the bony region of the ear canal it is possible to provide a dome configured to provide an improved output on existing speaker unit platform and to improve the sound quality due to the small residual volume and reduce the occlusion effect as described.

The dome is a dome for attachment to an in the ear canal element. The ear canal element may be an ear canal element from either a behind the ear (BTE) hearing aid or a receiver in the ear (RITE) hearing aid. The ear canal element may be the speaker unit of a BTE hearing aid or a RITE.

The dome is configured to be inserted into an ear canal of a user and comprises a front portion adapted to be brought into contact with an ear canal of a user. Hereby, it is possible to seal against the ear canal.

The dome comprises a through-going sound canal and an elongated intermediate portion extending between a front surface of the front portion facing a tympanic membrane when inserted into an ear canal.

Hereby, it is possible to deliver a sound output in an optimum manner through the sound canal towards the tympanic membrane (eardrum).

The sound canal may be a centrally arranged sound canal.

The dome comprises an attachment area configured to receive at least a portion of an in the ear canal element. The attachment area may have any suitable geometry and size.

At least the front portion is adapted to substantially reach into a bony region of the ear canal of a user. Accordingly, the occlusion effects can be reduced or even eliminated.

The dome according to the disclosure seals against at least a portion of the bony region of the ear canal, whereby the occlusion effect associated to sealing in the soft regions can be avoided. The dome may comprise:

a portion made in a hard material for retention on the in the ear canal element (e.g. a speaker unit) and to ensure the dome does not collapse in the ear and

a portion made in a softer material for providing a comfortable interface towards the ear canal.

According to another embodiment of the disclosure the dome comprises a rear portion adapted to be brought into contact with the ear canal, said rear portion forming at least a part of the front portion, wherein the attachment area is provided in a transition area between the rear portion and the front portion.

Hereby, the dome can receive at least a portion of the in the ear canal element, e.g. a speaker unit and transfer sound waves towards the tympanic membrane. The rear portion of the dome may be configured to support a part of the speaker in order to minimize the risk of damage to the walls of the ear canal. That is the rear portion substantially surrounds at least a part of the rear portion, to protect the walls of the ear canal.

According to a further embodiment of the disclosure the rear portion has a first diameter and the front portion has a second diameter, wherein the first diameter is smaller than, larger than or equal to the second diameter.

According to another embodiment of the disclosure the rear portion has a first diameter and the front portion has a second diameter, wherein the first diameter is larger than the second diameter.

According to a further embodiment of the disclosure the rear portion has a first diameter and the front portion has a second diameter, wherein the first diameter is equal to than the second diameter.

According to an even further embodiment of the disclosure the attachment area comprises an attachment structure, the attachment structure being configured to attach said in the ear canal element to said dome. Accordingly, the in the ear canal element, e.g. the speaker, may be attached to an attachment area, which comprises suitable attachment structures for receiving a corresponding attachment part of the speaker, when inserted into the dome. In this way the dome is easily mounted to the in the ear canal element by using e.g. an attachment structure providing a snap or clicking engagement between the in the ear canal element and the attachment area of the dome.

In more detail, the attachment structures of the dome may comprise an annular recess portion, which is provided in the attachment structure, wherein a diameter of the annular recess portion exceeds a diameter of the sound canal, said annular recess portion being configured to connect with said in the ear canal element. Accordingly, the attachment structure of the dome may be configured as an annular recess therein.

Hereby, it is possible to retain the (distal portion of the) ear canal element (e.g. a speaker unit) in the dome by means of the annular recess portion. Accordingly, the (distal portion of the) ear canal element (e.g. a speaker unit) can be attached to the attachment structure in an easy and reliable manner.

According to an even further embodiment of the disclosure at least one part of the attachment area is made in a first material, and the rear portion and/or the front portion is made in a softer material than said at least one part of said attachment area.

Hereby, it is possible to provide a front portion forming a soft interface towards the ear canal and ensure that the attachment area of the dome is made in a harder material preventing it from collapsing in the ear canal.

According to another aspect of the disclosure a surface area of the front portion is configured to abut the ear canal of a user, said surface area having a closed structure, and wherein at least one centrally arranged sound canal is arranged in said front portion and configured to allow sound to pass from said in the ear canal element to a tympanic membrane of a user's ear canal.

Hereby, it is possible to provide a dome by which it is possible to avoid/prevent acoustic feedback.

According to an even further embodiment of the disclosure the elongated intermediate portion of the dome forms part of the attachment area and is provided with surface structures along the length of said intermediate portion. Hereby, it is possible to reduce the mechanical stiffness of the attachment area and hereby increase the ability of the sound canal to bend. Furthermore, one or more of the surface structure may be formed as recesses in the material of the intermediate portion, where at least one recess as previously described may be configured as an attachment structure adapted to receive a corresponding attachment structure of a speaker.

According to a further embodiment of the disclosure the elongated intermediate portion of the dome forms part of said attachment area and is provided as a separate sleeve structure inserted or incorporated during production into the intermediate portion.

According to another embodiment of the disclosure the elongated intermediate portion is configured to be bendable and/or flexible to such an extent that said elongated intermediate portion is angled relative to a longitudinal axis of said rear portion at least during insertion of said dome into an ear canal of a user. Hereby, insertion of the dome into the ear canal is eased. This allows for an eased insertion of the dome, to reach into the bony region. Furthermore, also the adjustment of the dome to provide a tight and well-suitable fit is allowed by the elongated intermediate portion being bendable. Especially due to the fact that the ear canal bends along the length thereof, it is an advantage that the dome may be inserted in a flexible manner, which is improved at least by the construction of the intermediate portion as being bendable and flexible.

The elongated intermediate portion may be angled 25-40 degrees, such as 30-35 degrees, e.g. 32 degrees relative to a longitudinal axis of the rear portion since investigations has shown that a curvature of about 32 degrees is optimal with regards to the curvature of the body.

According to another aspect of the disclosure a hearing aid comprising a behind the ear element configured to be arranged behind the pinna of a user, an in the ear canal element configured to be arranged in the ear canal of a user and a dome which is arranged in connection with said in the ear canal element, wherein said dome comprises a front portion adapted to be brought into contact with an ear canal of a user, wherein said dome comprises a through-going sound canal and an elongated intermediate portion extending between the front portion and an attachment area of said dome, said attachment area being configured to receive at least a portion of the in the ear canal element, wherein at least the front portion is adapted to reach into a bony region of the ear canal of a user.

Hereby, it is possible to provide a hearing aid configured to provide a high sound pressure in the ear canal because of the reduced residual cavity thus enabling a larger hearing loss fitting range. Additionally, the occlusion effect can be decreased or even eliminated because the dome is placed in the bony hard part (i.e. the bony region) of the ear canal.

The hearing aid according to the disclosure makes it possible to make a better reproduction of low frequencies due to the efficient acoustic sealing of the dome towards the ear canal. In general a hearing aid according to the disclosure having a dome extending into the bony region improves the acoustic of the hearing aid creating a better hearing experience to the user of the hearing aid.

According to another embodiment of the disclosure the attachment area comprises a first attachment structure, and said in the ear canal element comprises a corresponding second attachment structure configured to attach said in the ear canal element to said dome. Hereby, it is possible to provide a reliable attachment of the ear canal element to the dome.

According to an even further embodiment of the disclosure the attachment structure of said attachment area is shaped as an annular recess portion, wherein said in the ear canal element comprises a corresponding shaped attachment member, preferably formed as a protrusion, configured to engage with said annular recess of said attachment structure. Hereby, it is possible to provide a reliable attachment of the dome.

According to another embodiment of the disclosure a diameter of the annular recess portion exceeds a diameter of the sound canal, said annular recess portion being configured to connect with said in the ear canal element. Hereby, the in the ear canal element is prevented from being displaced into the sound canal. It is achieved that that the in the ear canal element can be maintained in a fixed position.

According to an even further embodiment of the disclosure the ear canal element comprises a first portion and a second portion, wherein the first portion extends along a longitudinal axis that is angled relative to the longitudinal axis of the second portion. Hereby, it is possible to provide a hearing aid that is easy to insert into the ear canal.

According to another embodiment of the disclosure the hearing aid comprises a dome according to the disclosure.

According to an even further embodiment of the disclosure the attachment area of said dome is configured in such a manner that the centre of mass of said attachment area is provided substantially at a front surface of said rear portion.

According to an embodiment of the disclosure the dome is configured to be arranged on a standard speaker unit, and in a preferred embodiment, the dome is preferably oval in shape. However, any suitable shaping of the dome could be used.

According to an even further embodiment of the disclosure the rear portion is configured to support in the ear canal and optionally seal against the ear canal.

According to an embodiment of the disclosure the length of the elongated intermediate portion is in the range 2-10 mm, preferably 4-8 mm, such as 5-7 mm. In a preferred embodiment, the elongated intermediate portion may be 5.5 mmm which is optimal in view of the front portion intended to reach into the bony region, while the dome extension is maintained stabile to increase comfort of wearing the dome deeply inserted.

According to another embodiment of the disclosure the distance between the front portion and the rear portion is larger than 1 mm, preferably larger than 2 mm such as larger than 3 mm.

According to an even further embodiment of the disclosure the diameter of the intermediate portion exceeds the distance between the front portion and the rear portion.

According to another embodiment of the disclosure a rod member is attached to the distal end of the front portion. Hereby, it is possible to apply the rod member as an ear wax blocker.

According to a further embodiment of the disclosure the dome comprises an integrated wax filter for ear wax protection.

According to another embodiment of the disclosure the wax filter is detachably attached to the dome.

According to an even further embodiment of the disclosure a through-going opening is provided next to the rod member.

According to another embodiment of the disclosure the rear portion is provided with one or more openings. Hereby, it is possible to provide a comfortable solution as possible and limit occlusion effects. The rear dome may be configured to protect ear canal of the user and protect speaker unit.

According to an even further embodiment of the disclosure the outside of the rear portion and/or the first portion is polished for improved retention.

According to another embodiment of the disclosure the rear portion and/or the first portion has an oval or circular cross section.

According to an even further embodiment of the disclosure the dome comprises an integrated wax barrier/wax filter.

According to another embodiment of the disclosure the front portion and/or the rear portion comprises a number of ventilation canals. Hereby, it is possible to avoid vacuum when removing the dome from the ear.

According to an even further embodiment of the disclosure the sound canal is narrowed in its distal end. Hereby, it is possible to improve the wearing comfort.

According to another embodiment of the disclosure the angle between the longitudinal axis of the first portion and the longitudinal axis of the second portion is within the range of 20-40 degrees, preferably 25-38 degrees, such as 30-34 degrees.

According to an even further embodiment of the disclosure at least a portion of the dome is made in a shape-memory material.

According to another embodiment of the disclosure the shape-memory material is a shape-memory polymer.

According to an even further embodiment of the disclosure the shape-memory material is a shape-memory alloy. By applying a shape-memory material it is possible to make a dome that is easily inserted. During insertion a portion of the dome will be straight and thus facilitate insertion. The portion of the dome is expected to be easier to place in the ear canal compared to a softer material.

According to another embodiment of the disclosure the dome comprises a joint configured to be attached to a speaker of the in the ear canal element.

According to a further embodiment of the disclosure the joint is a ball joint.

According to another embodiment of the disclosure the joint is a snap joint.

According to a further embodiment of the disclosure the joint is a snap rotational joint, such as a screw.

### BRIEF DESCRIPTION OF DRAWINGS

The aspects of the disclosure may be best understood from the following detailed description taken in conjunction with the accompanying figures. The figures are schematic and simplified for clarity, and they just show details to improve the understanding of the claims, while other details are left out. Throughout, the same reference numerals are used for identical or corresponding parts. The individual features of each aspect may each be combined with any or all features of the other aspects. These and other aspects, features and/or technical effect will be apparent from and elucidated with reference to the illustrations described hereinafter in which:

FIG. 1 shows a hearing device according to an embodiment of the disclosure;

FIG. 2 shows a cross-sectional view of an ear canal;

FIG. 3 shows a hearing device according to an embodiment of the disclosure;

FIG. 4 shows a hearing device according to an embodiment of the disclosure arranged in the ear canal of a user;

FIG. 5 shows a hearing device according to an embodiment of the disclosure;

FIG. 6 shows a dome according to an embodiment of the disclosure;

FIG. 7 shows a hearing device according to an embodiment of the disclosure;

FIG. 8 shows another hearing device according to an embodiment of the disclosure;

FIG. 9 shows a hearing device according to an embodiment of the disclosure arranged in the ear canal of a user.

FIG. 10 shows a speaker and a dome with corresponding color markings according to an embodiment.

### DETAILED DESCRIPTION

The detailed description set forth below in connection with the appended drawings is intended as a description of various configurations. The detailed description includes specific details for the purpose of providing a thorough understanding of various concepts. However, it will be apparent to those skilled in the art that these concepts may be practiced without these specific details. Several aspects of the apparatus and methods are described by various blocks, functional units, modules, components, circuits, steps, processes, algorithms, etc. (collectively referred to as “elements”). Depending upon particular application, design constraints or other reasons, these elements may be implemented using electronic hard-ware, computer program, or any combination thereof.

A hearing device may include a hearing aid that is adapted to improve or augment the hearing capability of a user by receiving an acoustic signal from a user's surroundings, generating a corresponding audio signal, possibly modifying the audio signal and providing the possibly modified audio signal as an audible signal to at least one of the user's ears. The “hearing device” may further refer to a device such as an earphone or a headset adapted to receive an audio signal electronically, possibly modifying the audio signal and providing the possibly modified audio signals as an audible signal to at least one of the user's ears. Such audible signals may be provided in the form of an acoustic signal radiated into the user's outer ear, or an acoustic signal transferred as mechanical vibrations to the user's inner ears through bone structure of the user's head and/or through parts of middle ear of the user or electric signals transferred directly or indirectly to cochlear nerve and/or to auditory cortex of the user.

The hearing device is adapted to be worn in any known way. This may include i) arranging a unit of the hearing device behind the ear with a tube leading air-borne acoustic signals into the ear canal or with a receiver/loudspeaker arranged close to or in the ear canal such as in a Behind-the-Ear type hearing aid, and/or ii) arranging the hearing device entirely or partly in the pinna and/or in the ear canal of the user such as in an In-the-Ear type hearing aid or In-the-Canal/Completely-in-Canal type hearing aid, or iii) arranging a unit of the hearing device attached to a fixture implanted into the skull bone such as in Bone Anchored Hearing Aid or Cochlear Implant, or iv) arranging a unit of the hearing device as an entirely or partly implanted unit such as in Bone Anchored Hearing Aid or Cochlear Implant.

A “hearing system” refers to a system comprising one or two hearing devices, and a “binaural hearing system” refers to a system comprising two hearing devices where the devices are adapted to cooperatively provide audible signals to both of the user's ears. The hearing system or binaural hearing system may further include auxiliary device(s) that communicates with at least one hearing device, the auxiliary device affecting the operation of the hearing devices and/or benefitting from the functioning of the hearing devices. A wired or wireless communication link between the at least one hearing device and the auxiliary device is established that allows for exchanging information (e.g. control and status signals, possibly audio signals) between the at least one hearing device and the auxiliary device. Such auxiliary devices may include at least one of remote controls, remote microphones, audio gateway devices, mobile phones, public-address systems, car audio systems or music players or a combination thereof. The audio gateway is adapted to receive a multitude of audio signals such as from an entertainment device like a TV or a music player, a telephone apparatus like a mobile telephone or a computer, a PC. The audio gateway is further adapted to select and/or combine an appropriate one of the received audio signals (or combination of signals) for transmission to the at least one hearing device. The remote control is adapted to control functionality and operation of the at least one hearing devices. The function of the remote control may be implemented in a SmartPhone or other electronic device, the SmartPhone/electronic device possibly running an application that controls functionality of the at least one hearing device.

In general, a hearing device includes i) an input unit such as a microphone for receiving an acoustic signal from a user's surroundings and providing a corresponding input audio signal, and/or ii) a receiving unit for electronically receiving an input audio signal. The hearing device further includes a signal processing unit for processing the input audio signal and an output unit for providing an audible signal to the user in dependence on the processed audio signal.

The input unit may include multiple input microphones, e.g. for providing direction-dependent audio signal processing. Such directional microphone system is adapted to enhance a target acoustic source among a multitude of acoustic sources in the user's environment. In one aspect, the directional system is adapted to detect (such as adaptively detect) from which direction a particular part of the microphone signal originates. This may be achieved by using conventionally known methods. The signal processing unit may include amplifier that is adapted to apply a frequency dependent gain to the input audio signal. The signal processing unit may further be adapted to provide other relevant functionality such as compression, noise reduction, etc.

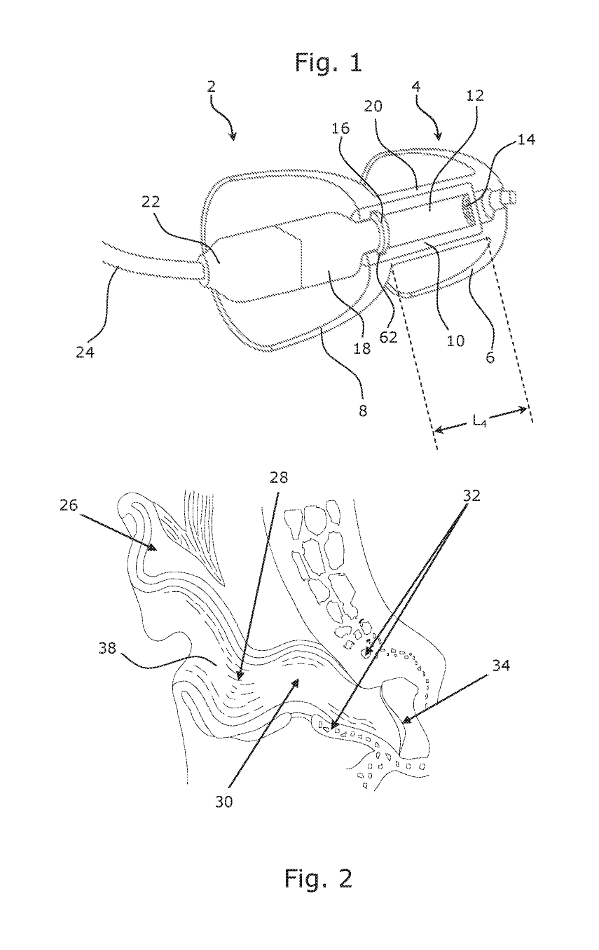

Now referring to FIG. 1, the general concept according to the disclosure is illustrated. FIG. 1 illustrates a hearing aid (also denoted hearing device) which comprises a behind the ear (BTE) element (not shown) configured to be arranged behind the pinna 26 (c.f. FIG. 2) of a user. An in the ear canal element 22, in the following referred to as a speaker 22 is in one end connected to a tube 24, which in case of a receiver-in-the ear (RITE) solution hearing aid is configured to provide an electrical connection between a BTE unit and the receiver (i.e speaker) arranged in the ear canal of a user. In more detail, the speaker is arranged in a dome 4, where the dome 4 comprises at least a front portion 6 adapted to be brought into contact with an ear canal 38 of a user and a through-going sound canal 12. As illustrated in FIG. 1 an elongated intermediate portion 20 is arranged in connection with the front portion 6 of the dome 4 and the speaker 22 of the hearing aid. In more detail, the intermediate portion 20 extends between the front portion 6 and an attachment area 46 (c.f. FIG. 8) of the dome, where the attachment area 46 is configured to receive at least a portion of the in the speaker. As will be apparent throughout the description, at least the front portion 6 of the dome is adapted to reach into a bony region 32 of the ear canal 38 of a user.

In the following, embodiments of the hearing aid and corresponding dome will be described in more detail, where corresponding features of each embodiment is given same reference numerals.

Accordingly, FIG. 1, illustrates a hearing device, such as a hearing aid according to an embodiment of the disclosure. FIG. 1 illustrates a schematic, perspective cut away side view of hearing device 2 according to an embodiment. The hearing device 2 comprises a dome 4 and a speaker 22 electrically connected to a connection structure 24 formed as a sound tube connecting the speaker 22 with a Behind-the-ear unit (BTE, not shown) of the hearing device. The hearing device 2 comprises a main module 18 comprising the speaker 22 and an attachment portion 16 provided as a protruding flange or protrusion structure attached to an annular recess portion 62 provided in an intermediate portion 20 of the dome 4. In more detail, the speaker 20 forms part of the main module 18, and comprises the above mentioned attachment structured (also referred to as a second attachment structure), which may be formed as a protrusion, preferably a protruding flange of the main module 18 or the speaker 22. In the embodiment shown, the protruding flange is configured to be inserted into a corresponding recess 62 in the dome 4.

The dome 4 comprises a rear portion 8 and a front portion 6 substantially connected by the intermediate elongated portion 20. The intermediate elongated portion 20 may be configured as an insert element 10 (e.g. made in a resilient material), which may be attached into a cavity provided in the intermediate portion 20. The insert element 10 has a length L₄ and is provided with a through-going sound canal 12. The insert element accordingly forms a part or structure of the intermediate portion enabling the intermediate portion 20 to at least receive the protruding flange portion of the speaker. Accordingly, in the following, the intermediate portion may be described to include the insert element 10. However it should be understood, that the insert element 10, could be a molded part of the intermediate portion, and thus of the dome, but that it could also be that the insert element is a separate part, which is inserted into the intermediate portion upon assembly and production of the dome.

As may be seen from FIG. 1, a removable attached wax filter 14 is inserted in the distal end of the sound canal 12 for wax protection. It should be noted that this wax filter is provided for protecting wax or other foreign objects from entering the sound canal of the speaker.

FIG. 2 illustrates a cross-sectional view of an ear canal 38 and the surrounding structures of a user. The pinna 26, the eardrum 34 as well as the bony portion 32 (i.e the bony hard part) of the ear canal 38 are indicated in FIG. 2. It can be seen that the ear canal 38 comprises a first bend 28 and a second bend 30. It should be noted that when referring to deep insertion into the ear canal, or insertion into the bony region, it is understood that at least the front portion 6 of the dome is inserted from the side of the pinna and guiding deep into the ear canal past the first and second bends to reach the bony region 32.

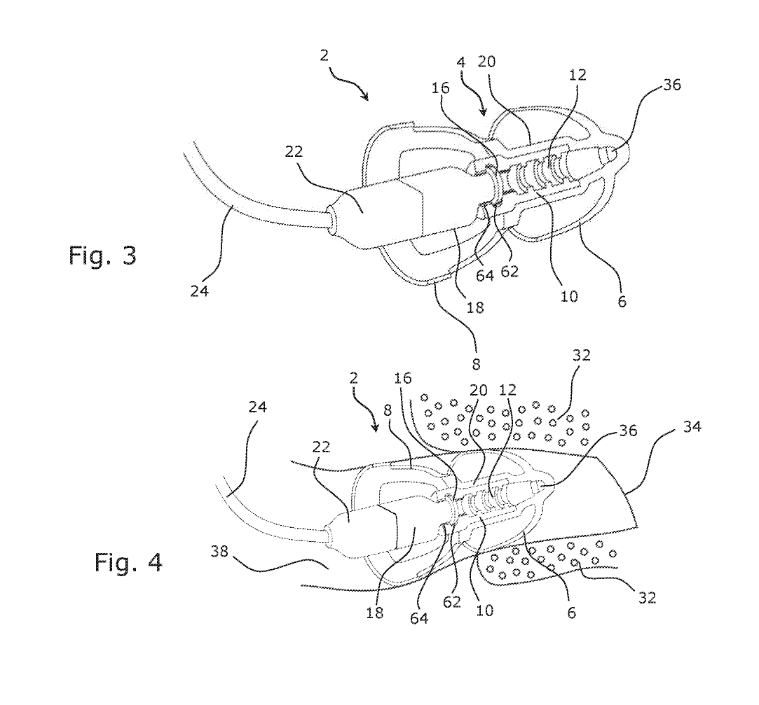

FIG. 3 illustrates a schematic, perspective cut away side view of a hearing device 2 according to an embodiment of the disclosure. The hearing device 2 corresponds to the one shown in FIG. 1. The dome 4 is substantially similar to the dome of FIG. 1, why the same numerals describing equal features are maintained.

The dome 4 comprises a rear portion 8 and a front portion 6 and an intermediate portion 20 extending there between and defining a through-going sound canal 12. An insert element 10 provided with annular structures at the inside surface is inserted into a cavity of the intermediate portion 20.

An opening 36 is provided in the distal end of the front portion 6. The insert element 10 comprises a proximal area 64 having a smaller inner diameter than the annular recess portion 62 into which the attachment portion 16 of the speaker unit 22 is attached.

FIG. 4 illustrates a hearing device 2 as the one shown in FIG. 3 arranged in the ear canal 38 of a user. It can be seen that the front portion 6 of the dome 4 is inserted into and thus seals against the bony portion of the an ear canal of a user in front of the ear drum 34, whereas the rear portion 8 of the dome 4 is brought into contact with the outermost portion of the ear canal 38.

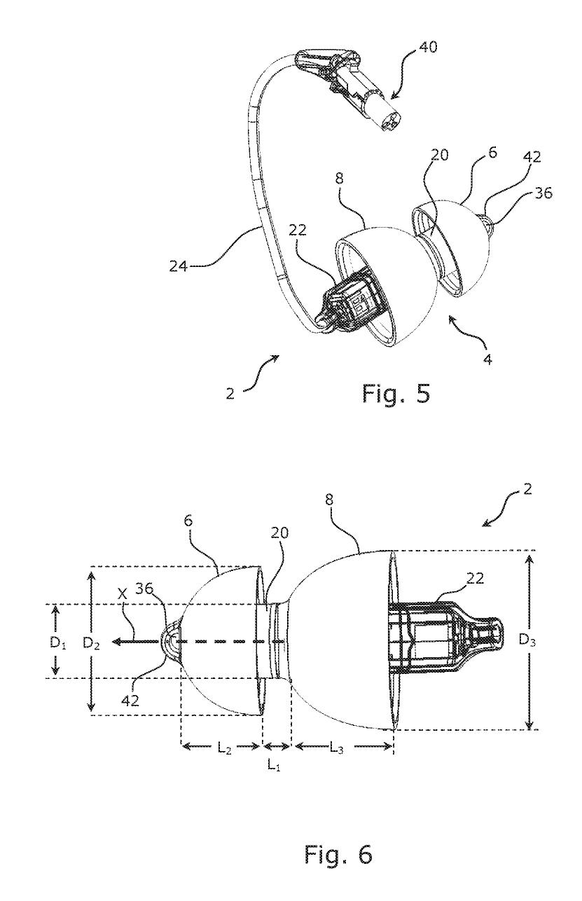

FIG. 5 illustrates a hearing device 2 according to an embodiment of the disclosure. The hearing device 2 comprises a speaker 22 attached to a dome 4 having a rear portion 8, a front portion 6 and an intermediate portion 20 extending there between. The speaker 22 is connected to a tube 24 electrically connected to a plug 40 for being inserted into a hearing device housing (e.g. a BTE hearing device).

The front end of the dome 4 is provided with an arced rod member 42 provided with an opening 36.

FIG. 6 illustrates a schematic, side view of a dome 4 corresponding to the one shown in FIG. 5. The dome 4 comprises a rear end 8 having an outer diameter D₃ that exceeds the outer diameter D₂ of the front end 6 of the dome 4. The intermediate portion 20 extending along the longitudinal axis X of the dome 6 between the front end 6 and the rear end 8 has an outer diameter D₁ that is smaller than the outer diameter of the front end 6.

The arced rod member 42 provided with an opening 36 at the front end of the dome 4 is symmetrically arranged. The length L₃ of the rear end 8 of the dome 4 exceeds the length L₂ of the front end 6 of the dome 4. It can furthermore be seen that the front end 6 is displaced a distance L₁ from the rear end 8.

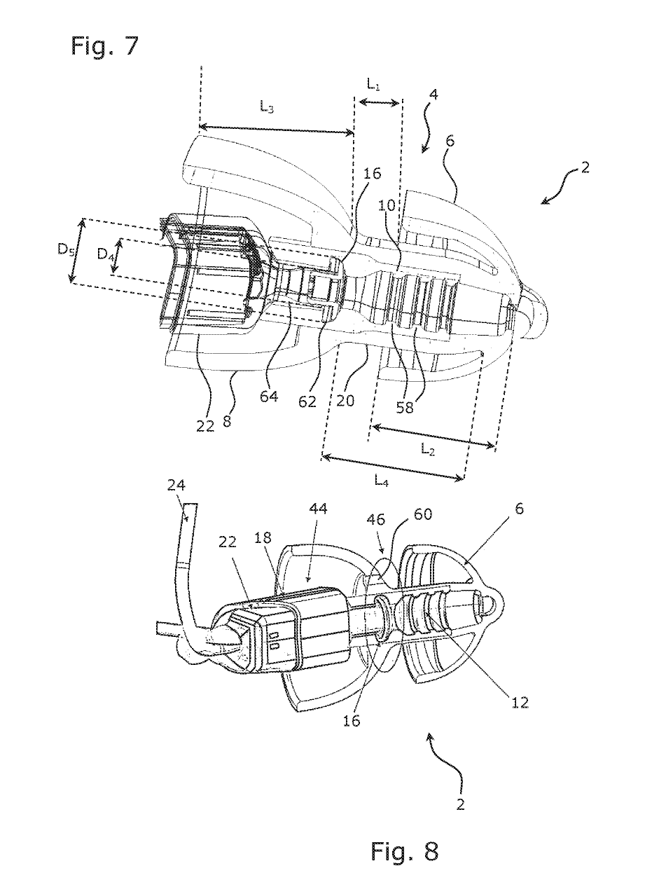

FIG. 7 illustrates a schematic, perspective, cross-sectional side view of a hearing device 2 according to an embodiment of the disclosure. The hearing device 2 comprises a speaker 22 attached to a dome 4. The dome 4 comprises a rear portion 8 having a length L₃ and an intermediate portion 20 having a length L₄ extending in extension of the rear portion 8. A front portion 6 having a length L₂ is provided at the distal end of the intermediate portion 20. The length L₁ of the space between the rear portion 8 and the front portion 6 is indicated.

The speaker unit 22 is attached to an annular recess portion 62 of the dome 4 by means of an attachment portion 16 formed as a flange. The dome 4 is equipped with an insert element 10 comprises a proximal area 64 having a smaller inner diameter D₄ than the diameter D₅ of the annular recess portion 62 into which the attachment portion 16 of the speaker unit 22 is attached.

The insert element 10 is provided with a through-going canal provided with surface structures 58 along the length of said intermediate portion 20. These structures 58 reduce the mechanical stiffness of the insert element 10 and hereby increase its ability to bend. Furthermore, the structures 58 also provides capillary traps for ear wax entering the interior of the dome from the end of the front portion facing the ear drum. That is, each “groove” of the structure 58 creates a wax-guard, which prevents wax from mitigating along the length of the elongated intermediate portion, since the “grooves” collects wax therein.

Also illustrated in FIG. 7 is how a portion of the front dome facing towards the rear dome has a slightly thicker material layer than the remaining of the from. This slightly thicker part of the front dome ensures that the dome does not collapse in the ear.

FIG. 8 illustrates a hearing device 2 basically corresponding to the one shown in FIG. 7. The hearing device 2 comprises a main structure 44 having a main module 18 comprising a speaker 22. The main structure 44 is attached to the attachment area 46 of a dome 4 having a rear portion 8 provided with an opening 60, a front portion 6 equipped with a structured through-going canal 12.

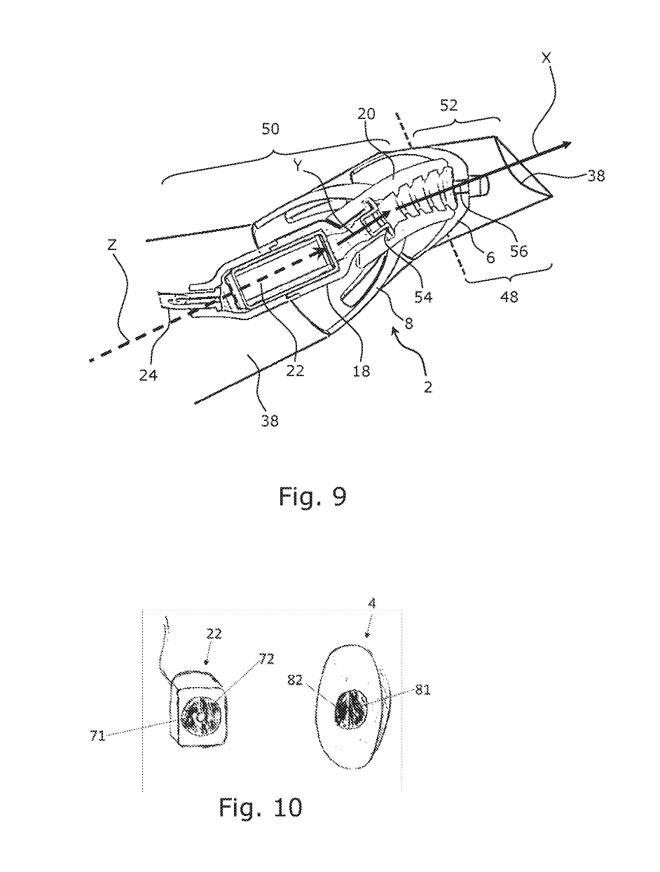

FIG. 9 illustrates a hearing device 2 corresponding to the one shown in FIG. 7 arranged in the ear canal 38 of a user. It can be seen that a speaker unit 22 connected to a tube 24 is arranged in an enclosing main module 18 having a distal end inserted into an annular recess portion provided in an intermediate portion 20 being part of a dome having a rear portion 8, a front portion 6 provided with an opening 56. A filter 54 is provided in the front end of the main module 18.

The front portion 6 of the dome is arranged in the bony region 48 of the ear canal 38. The longitudinal axis Z of the speaker unit 22 (and thus the rear portion of the main module 18) is angled relative to the longitudinal axis Y of the front portion of the main module 18. The rear portion of the main module 18 and the front portion of the main module 18 constitute a dynamic section 50, whereas the distal end of the front portion 6 of the dome constitute a static section 52. The longitudinal axis X of the front portion 6 of the dome is angled relative to the longitudinal axis Y of the front portion of the main module 18. Accordingly, the dome can be extended deep into the ear canal 38.

Furthermore illustrated in at least FIG. 8 it is seen that the intermediate elongated portion narrows towards the end reaching into the front dome portion, which entails a greater wearing comfort.

For providing a sufficient and correct connection between the speaker 22 and the dome 4, the dome 4 and the speaker 22 may in an embodiment be provided with a color coding. Accordingly, in an embodiment both the speaker 22 and the dome may be provided with a 2-sided color scheme, where one side illustrates a first color and a second side illustrates a second color. That is, upon attaching the speaker 22 in the dome 4, the color codings indicates to the user or HCP at which orientation the speaker 22 should be connected to the dome in order to obtain a perfect fit and seal of the speaker to the dome. That is, the speaker should be oriented such that the color markings of the dome, matching the color markings of the speaker, when connected to the speaker abuts the corresponding colors. Preferably the color coding of the speaker is provided on the attachment portion of the speaker. Reference is made to FIG. 10, which shown a speaker 22, having a first color marking 71 and a second color marking 72 corresponding to a first color marking 81 and a second color marking 82 of a dome 4.

In an alternative embodiment, a part of the dome may be colored with a right/left indication. That is, the an inner portion of e.g. the rear portion, may be colored with a color indicating that the dome is intended to be connected with a corresponding colored speaker unit. Incorporating a color into the dome material, either directly or through e.g. an o-ring, a visual indicator in the usual transparent domes is given to be the HCP and/or user of the hearing aid to ease operation thereof.

As used, the singular forms “a,” “an,” and “the” are intended to include the plural forms as well (i.e. to have the meaning “at least one”), unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will also be understood that when an element is referred to as being “connected” or “coupled” to another element, it can be directly connected or coupled to the other element but an intervening elements may also be present, unless expressly stated otherwise. Furthermore, “connected” or “coupled” as used herein may include wirelessly connected or coupled. As used herein, the term “and/or” includes any and all combinations of one or more of the associated listed items. The steps of any disclosed method is not limited to the exact order stated herein, unless expressly stated otherwise.

It should be appreciated that reference throughout this specification to “one embodiment” or “an embodiment” or “an aspect” or features included as “may” means that a particular feature, structure or characteristic described in connection with the embodiment is included in at least one embodiment of the disclosure. Furthermore, the particular features, structures or characteristics may be combined as suitable in one or more embodiments of the disclosure. The previous description is provided to enable any person skilled in the art to practice the various aspects described herein. Various modifications to these aspects will be readily apparent to those skilled in the art, and the generic principles defined herein may be applied to other aspects.

The claims are not intended to be limited to the aspects shown herein, but is to be accorded the full scope consistent with the language of the claims, wherein reference to an element in the singular is not intended to mean “one and only one” unless specifically so stated, but rather “one or more.”

Unless specifically stated otherwise, the term “some” refers to one or more.

Accordingly, the scope should be judged in terms of the claims that follow.

1. A dome for attachment to an in the ear canal element, said dome being configured to be inserted into an ear canal of a user and comprising a front portion adapted to be brought into contact with an ear canal of the user, wherein said dome comprises a through-going sound canal and an elongated intermediate portion extending between a front surface of the front portion facing a tympanic membrane when inserted into an ear canal and an attachment area of said dome, said attachment area being configured to receive at least a portion of an in the ear canal element, wherein at least the front portion is adapted to substantially reach into a bony region of the ear canal of the user.

2. Dome according to claim 1, wherein said dome further comprises a rear portion adapted to be brought into contact with the ear canal, said rear portion forming at least a part of said front portion, wherein said attachment area is provided in a transition area between said rear portion and said front portion.

3. Dome according to claim 2, wherein the rear portion has a first diameter) and the front portion has a second diameter, wherein the first diameter is smaller than, larger than or equal to the second diameter.

4. Dome according to claim 1, wherein said attachment area comprises an attachment structure, said attachment structure being configured to attach said in the ear canal element to said dome.

5. A dome according to claim 4, wherein an annular recess portion is provided in the attachment structure, wherein a diameter of the annular recess portion exceeds a diameter of the sound canal, said annular recess portion being configured to connect with said in the ear canal element.

6. Dome according to claim 1, wherein at least one part of said attachment area is made in a first material, and said rear portion and/or said front portion is made in a softer material than said at least one part of said attachment area.

7. A dome according to claim 1, wherein a surface area of the front portion is configured to abut the ear canal of a user, said surface area having a closed structure, and wherein at least one centrally arranged sound canal is arranged in said front portion and configured to allow sound to pass from said in the ear canal element to a tympanic membrane of a user's ear canal.

8. A dome according to claim 1 wherein said elongated intermediate portion of said dome forms part of said attachment area and is provided with surface structures along the length of said intermediate portion.

9. Dome according to claim 1, wherein said elongated intermediate portion is configured to be bendable and/or flexible to such an extent that said elongated intermediate portion is angled relative to a longitudinal axis of said rear portion at least during insertion of said dome into an ear canal of a user.

10. A hearing aid comprising:
a behind the ear element configured to be arranged behind the pinna of a user;
an in the ear canal element configured to be arranged in the ear canal of a user; and
a dome which is arranged in connection with said in the ear canal element, wherein said dome comprises
a front portion adapted to be brought into contact with an ear canal of a user,
wherein said dome comprises a through-going sound canal and
an elongated intermediate portion extending between the front portion and an attachment area of said dome,
said attachment area being configured to receive at least a portion of the in the ear canal element, wherein
at least the front portion of said dome is adapted to reach into a bony region of the ear canal of a user.

11. Hearing aid according to claim 10, wherein said attachment area comprises a first attachment structure, and said in the ear canal element comprises a corresponding second attachment structure configured to attach said in the ear canal element to said dome.

12. Hearing aid according to claim 11, wherein said attachment structure of said attachment area is shaped as an annular recess portion, wherein said in the ear canal element comprises a corresponding shaped attachment member, preferably formed as a protrusion, configured to engage with said annular recess of said attachment structure.

13. Hearing aid according to claim 12, wherein a diameter of the annular recess portion exceeds a diameter of the sound canal, said annular recess portion being configured to connect with said in the ear canal element.

14. Hearing aid according to claim 10, wherein said in the ear canal element comprises a first portion and a second portion, wherein the first portion extends along a longitudinal axis (Z) that is angled relative to the longitudinal axis (Y) of the second portion.

15. Hearing aid according to claim 10, wherein said hearing aid comprises a dome according to one of claims 1 to 9.

16. Hearing aid according to claim 10, wherein said attachment area of said dome is configured in such a manner that the centre of mass of said attachment area is provided substantially at a front surface of said rear portion

17. Dome according to claim 2, wherein said attachment area comprises an attachment structure, said attachment structure being configured to attach said in the ear canal element to said dome.

18. Dome according to claim 3, wherein said attachment area comprises an attachment structure, said attachment structure being configured to attach said in the ear canal element to said dome.

19. Dome according to claim 2, wherein at least one part of said attachment area is made in a first material, and said rear portion and/or said front portion is made in a softer material than said at least one part of said attachment area.

20. Dome according to claim 3, wherein at least one part of said attachment area is made in a first material, and said rear portion and/or said front portion is made in a softer material than said at least one part of said attachment area.
